(19) United States
(12) Patent Application Publication
(10) Pub. No.: US 2009/0021163 A1
(43) Pub. Date: Jan. 22, 2009

(54) Carrier element on which an Hg-containing material for application in a discharge lamp is formed, and a method for its production and a discharge lamp with such a carrier element

(75) Inventors: Christian Harzig, Mering (DE); Erolf Weinhardt, Diedorf (DE)

Correspondence Address: OSRAM SYLVANIA INC, 100 ENDICOTT STREET, DANVERS, MA, 01923, US

(73) Assignee: OSRAM GESELLSCHAFT MIT BESCHRANKTER HAFTUNG, Munchen (DE)

(21) Appl. No.: 12/219,341

(22) Filed: Jul. 21, 2008

(30) Foreign Application Priority Data
Jul. 20, 2007 (DE) 10 2007 033 878.5

(51) Int. Cl. H01J 17/26; H01J 9/00

(52) U.S. Cl. 313/565; 445/46

(57) ABSTRACT

A carrier element, on which an Hg-containing material for application in a discharge lamp (1) is formed, has at least one depression (12, 20 to 23), in which the Hg-containing material (17) is arranged. A method for producing such a carrier element and to a discharge lamp with such a carrier element is also disclosed.

Carrier element on which an Hg-containing material for application in a discharge lamp is formed, and a method for its production and a discharge lamp with such a carrier element

### TECHNICAL FIELD

invention relates to a carrier element on which an Hg-containing material for application in a discharge lamp is formed, and to a method for producing such a carrier element. Furthermore, the invention relates to a discharge lamp with such a carrier element.

### PRIOR ART

The introduction of mercury into discharge lamps, in particular low-pressure discharge lamps, is known and can take place, for example, using a metal strip which is provided with a corresponding coating. WO 98/14983 has disclosed a low-pressure discharge lamp in which a carrier element, which is in the form of a type of plate, is arranged in a discharge vessel of the lamp and in particular is fastened, for example, on an electrode frame. The surface of the carrier element is coated and the carrier element has firstly a coating with an Hg-containing material and secondly a coating with a getter material. The two coatings are formed separately from one another. The carrier element can be a substantially planar plate, but may also be a bent plate.

Conventionally, such a surface coating is carried out using a screw-type vibration system, with a corresponding powder being applied to the carrier element and distributed for this purpose. This procedure makes the metering accuracy entirely dependent on the metering system and relatively inaccurate. As a result, the mercury concentration fluctuates, which means that the functionality of the discharge lamp can be impaired.

### DESCRIPTION OF THE INVENTION

The object of the present invention is to provide a carrier element with which the metering of the Hg-containing material can be improved. In particular, it is also an object to provide such a production method for a carrier element. Likewise, a discharge lamp with a carrier element is intended to be provided in which the functionality can be improved by more precise and accurate setting of the quantity of mercury.

These objects are achieved by a carrier element which has the features as claimed in claim 1 and by a method which has the features as claimed in claim 15. Likewise, these objects are achieved by a discharge lamp which has the features as claimed in claim 12.

A carrier element according to the invention is designed for application in a discharge lamp and is moreover provided with an Hg-containing material. The carrier element has at least one depression, in which the Hg-containing material is arranged. In contrast to the prior art, specific shaping of the carrier element is therefore carried out to the extent that at least one depression defining a specific volume is provided, as a result of which a locally concentrated and therefore locally focused application of the Hg-containing material is made possible. No surface coating of the carrier element is therefore carried out any more, but a volume coating. As a result of this configuration, a substantially more precise metering and application of the Hg-containing material and therefore also of the mercury concentration on the carrier element can be carried out. In contrast to the surface coating known from the prior art, such volume coating also ensures the application of very low quantities of mercury. As a result, superfluous and unnecessary addition of mercury can be avoided and nevertheless the high functionality can be ensured. Furthermore, given such a configuration of the carrier element with at least one depression, in which the Hg-containing material is arranged, there are no longer the fluctuations in the application of the powder associated with a screw-type vibration system. The volume to be filled is very constant and precise.

Preferably, the Hg-containing material is formed exclusively in the depression. The surfaces running around the depression and also the other surfaces of the carrier element outside of the depression are free from mercury material. In addition to precise setting of the Hg concentration and therefore also of the metering, this can also ensure the local and therefore locally focusable application of the Hg-material.

In particular it is provided that a depression is in the form of a groove. Geometric structures such as trenches are therefore provided as depressions, which can be at least partially filled with the Hg-containing material. Such a groove may have a straight profile. An elongate structure of a groove can, however, also be designed to be curved, at least in regions. A curvature is understood to mean both a continuous arcuate configuration and also an angular construction. The groove may be designed to run transversely, longitudinally or at an angle.

In cross section, such a depression in the form of a groove may be designed with or without corners. For example, a construction which is rectangular or in the form of a U in cross section can be provided. Likewise, however, a V-shaped cross-sectional shape can also be provided. These are merely exemplary dimensions and geometric configurations of a depression which should not be understood as being exhaustive.

In addition to an elongate structure of a depression, for example in the form of a groove or a trench, however, a hole-like or bowl-like structure can also be provided. In particular, such a configuration is designed as a type of blind hole, which means that the hole is not continuous but is closed at the base. Both in the case of elongate geometrical configurations of a depression and in the case of configurations in the form of blind holes, at least two depressions can be provided in the carrier element. The application of such a plurality of depressions can be provided so as to be distributed as desired on the carrier element. However, an ordered arrangement with, for example, equidistant positioning can also be provided.

Preferably, a depression is completely filled with Hg-containing material. As a result of such a configuration, the Hg quantity for a carrier element can be metered in a particularly precise manner. Since the volume of a depression can be predetermined very precisely, such complete filling of the depression can also make it possible to comprehend very precisely what quantity of mercury is present. Preferably, the filling of a depression with Hg-containing material is provided in such a way that the material is formed planar and flush with the surface of the carrier element which surrounds the depression at the upper edge.

In particular it can be provided that the complete filling of the depression with Hg-containing material is provided before the material is pressed and, after the pressing, the upper side of the material in the depression is lower than the level of the surface of the carrier element. It can also be provided that the complete filling is formed after the pressing and is therefore quasi a step-free transition with the surface of the carrier element surrounding the depression.

In particular it is also provided that getter material is arranged in the depression. Therefore, both Hg-containing material and getter material is provided in a depression. There is therefore quasi a mixture of the two different materials in a depression. In this case, too, the space-saving configuration in comparison with the known prior art can be made possible, in which, in addition to the space-intensive surface coating, separation of the two materials by separate layers formed separately from one another is also provided.

Preferably, the Hg-containing material is a powder, which is introduced in particular into the depression and is then pressed into the depression. Only the Hg-containing material which is located in the depression is subjected to such pressing. The Hg-containing material which is applied during the production possibly also to the other surfaces of the carrier element is not pressed and, after the pressing of the Hg-containing material in a depression, is removed, in particular sucked away, from these surfaces. As a result, the desired Hg-free implementation of the surfaces of the carrier element can be achieved.

The carrier element is preferably formed from metal and is preferably designed as a plate-like part. It can also be referred to as a metal strip.

In particular it is provided that the quantity of mercury can be metered depending on the concentration of the mercury in the material formed in the depression and/or on the number of depressions and/or on the volume of at least one depression. By means of at least one of these mentioned parameters, the quantity of mercury provided per carrier element can be fixed in a very precise manner and in particular also the introduction of extremely low quantities of mercury can take place simply and precisely.

Preferably, at least one further depression is provided, in which Hg-free material, in particular getter material, is formed. Given such a configuration, the carrier element therefore comprises at least one depression, in which Hg-containing material is arranged, and at least one further depression which does not contain any mercury material. As a result, a sufficient quantity of getter material can also be provided depending on requirements and the situation, and this getter material can always be metered precisely and individually.

A further aspect of the invention relates to a discharge lamp with a discharge vessel and at least one electrode arranged therein, and to a carrier element according to the invention or an advantageous configuration thereof, the carrier element being arranged in the discharge vessel. In particular, the discharge lamp is designed as a low-pressure discharge lamp. Both discharge lamps with only one electrode, for example a lamp filament, and discharge lamps with two electrodes can be provided. In particular, fluorescent lamps which have a linear discharge vessel or else a discharge vessel which is bent or curved at at least one point can therefore also be provided.

By means of such a discharge lamp, the quantity of mercury can be metered very precisely and can also be designed to have a relatively low quantity, as a result of which the functionality and in particular the environmental friendliness of the lamp can be improved since it has a lower quantity of heavy metal.

It has proven to be particularly preferred if the carrier element is arranged on an electrode frame of the discharge lamp. It can thus be provided that the carrier element is arranged on a power supply line of the electrode frame. A power supply line is provided for holding the electrode and is electrically connected on the outside to the electrical contacts of the discharge lamp. Furthermore, however, it can also be provided that the carrier element is arranged on a central support of the electrode frame. A central support is in particular provided for the purpose of holding a dome, which is preferably in the form of an annular hollow body. Such a dome surrounds an electrode arranged in the discharge vessel. This is provided in particular, for example, in the case of fluorescent lamps. The electrode therefore extends in the tubular hollow body, which forms the dome, and which is arranged on the central support.

It can preferably also be provided that the carrier element in particular represents this dome. The carrier element and the dome are therefore one component, with this component therefore being multifunctional. As a result, space is saved and there is a reduction in the number of component parts of a discharge lamp.

In a method according to the invention for producing a carrier element which has Hg-containing material and can be provided and used for a discharge lamp, at least one depression is formed in the carrier element, and the Hg-containing material is introduced into this depression. The method according to the invention therefore does not permit surface coating of a carrier element but volume coating. As a result, very precise mercury concentrations per carrier element can be set and in particular the introduction of very low quantities of mercury can be achieved with little complexity.

Preferably, the Hg-containing material is distributed over the carrier element as a powder and only the material located in the depression is pressed into the depression once it has been introduced. Preferably, the Hg-containing material located outside the depression is removed, in particular sucked away, once the Hg-containing material contained in the depression has been pressed. A vibration system can be provided for the application. The metering quantity of powder is now dependent on the volume of the depression in the metal strip and is no longer subject to any fluctuations of the vibration system. The volume to be filled is known precisely and therefore the concentration dimensioning of the mercury per carrier element is very constant. The quantity of mercury is fixed depending on the depth and breadth of the depression because the mercury concentration in the powder can be produced very precisely.

Advantageous embodiments of the carrier element according to the invention can be regarded as advantageous embodiments of the discharge lamp and of the method according to the invention.

### BRIEF DESCRIPTION OF THE DRAWINGS

Exemplary embodiments of the invention will be explained in more detail below with reference to schematic drawings, in which:

FIG. 1 shows a sectional illustration through an exemplary embodiment of a discharge lamp;

FIG. 2 shows a perspective illustration of a detail of a carrier element according to the invention in accordance with a first exemplary embodiment;

FIG. 3 shows a perspective illustration of a detail of a carrier element according to the invention in accordance with a second exemplary embodiment;

FIG. 4 shows a sectional illustration of the carrier element shown in FIG. 2;

FIG. 5 shows a sectional illustration of the carrier element shown in FIG. 3;

FIG. 6 shows a schematic plan view of a carrier element in accordance with a third exemplary embodiment;

FIG. 7 shows a schematic plan view of a carrier element in accordance with a fourth exemplary embodiment;

FIG. 8 shows a schematic plan view of a carrier element in accordance with a fifth exemplary embodiment; and

FIG. 9 shows a schematic plan view of a carrier element in accordance with a sixth exemplary embodiment.

### PREFERRED EMBODIMENT OF THE INVENTION

Identical or functionally identical elements have been provided with the same reference symbols in the figures.

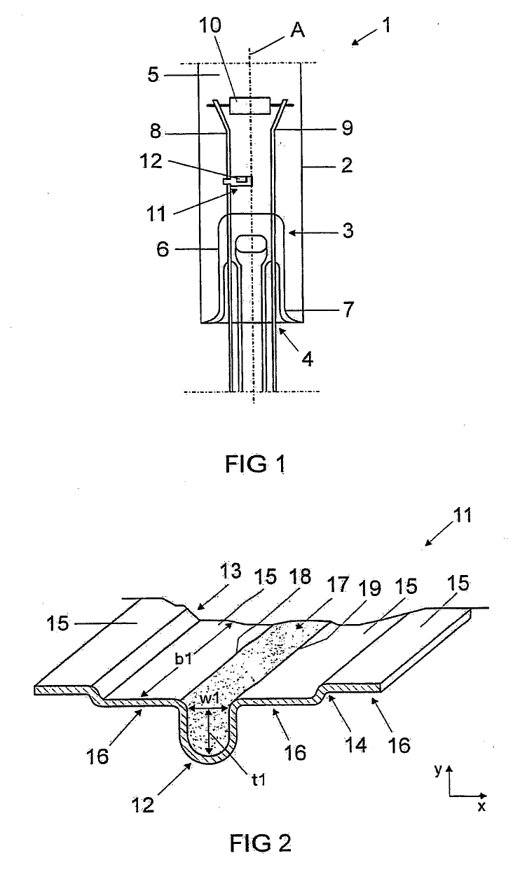

FIG. 1 shows a schematic sectional illustration of a detail of a discharge lamp 1 in the form of mercury vapor low-pressure discharge lamp. The discharge lamp 1 comprises a tubular discharge vessel 2, which can be linear, U-shaped or else bent several times. The ends of the discharge vessel 2 are filled in a gas-tight manner. An electrode frame 3 of the discharge lamp 1 extends from one end 4 of the discharge lamp 1 into the discharge space 5 formed in the interior of the discharge vessel 2. The electrode frame 3 comprises a glass plate-like stand 6, whose widened rim 7 is fused in a gas-tight manner to the end 4 of the discharge vessel 2.

Furthermore, the electrode frame 3 has two separate power supply lines 8 and 9, which are provided for holding an electrode 10 in the form of a lamp filament. Furthermore, a carrier element 11 is arranged in the discharge space 5 of the discharge lamp 1. In the embodiment shown in FIG. 1, the carrier element 11 is fastened on the power supply line 8. The carrier element 11 is illustrated schematically in FIG. 1. At least one depression 12 is formed on the carrier element 11, and Hg-containing material is arranged in this depression. The carrier element 11 can also have a plurality of such depressions 12, which can be designed to be geometrically identical or else different. The carrier element 11 is in the form of a metal strip and at first approximation is in the form of a type of plate.

In addition to the application of the carrier element 11 on the power supply line 8 shown in FIG. 1, it can also be provided that the carrier element 11 is fastened on the power supply line 9.

However, it can likewise also be provided that a dome (not illustrated in FIG. 1) for the electrode 10 is provided, this dome being designed as a tubular hollow body, which surrounds the electrode 10. Preferably, the horizontally running longitudinal axis (not shown in FIG. 1) of the electrode 10 and the longitudinal axis of such a dome has the same orientation. In particular, a coaxial arrangement is provided.

Given such a configuration, the carrier element 11 can at the same time represent this dome.

The dome is arranged precisely in position in particular with a linear central support (not illustrated), this central support, as an additional component to the power supply lines 8 and 9, being associated with the electrode frame 3. It can also be provided that the carrier element 11 is fastened on this mentioned central support, on which the dome is arranged.

FIG. 2 shows a first exemplary embodiment of the carrier element 11 in a perspective illustration as a detail. The plate-like structure of the carrier element 11 in the form of a metal strip is shown. Approximately in the center, the depression 12 is designed as a groove or trench, which extends over the entire breadth b1 of the carrier element 11. The depression 12 has a width w1 and depth t1. In the embodiment shown, the depth t1 is greater than the width w1. In principle, it is preferred if the geometry of the depression 12 is designed in such a way that the width w1 is less than or equal to the depth t1. However, it can also be provided that the width w1 is slightly greater than the depth t1. In principle, the configuration of the carrier element 11 can result in result in a volume coating. This means that surfaces in the form of upper sides 15 and in the form of lower sides 16 of the carrier element 11 which lie outside the depression 12 are free from mercury. A surface coating is therefore not provided on the carrier element 11.

In the embodiment shown in FIG. 2, the carrier element 11 has steps 13 and 14, as a result of which there is a relatively small difference in level in comparison with the depth t1. However, it is also possible for these steps 13 and 14 not to be formed and they are not essential to the invention.

A lower level of subregions of the carrier element 11 in comparison with other subregions as shown in FIG. 2 and as a result of the steps 13 and 14 which are positioned relatively far apart from one another is not understood in the context of the invention as a depression as is defined by the configuration of the depression 12. This is because, as can clearly be seen, the graduations 13 and 14 in the y direction represent a markedly smaller dimension in comparison with the gap between the two steps 13 and 14 in the x direction. Such variations in level with markedly greater dimensions in the x direction in comparison with those in the y direction can no longer be regarded as depressions within the meaning of this application.

In the embodiment shown, the depression 12 has a substantially U-shaped shape without any corners in a longitudinal sectional illustration. This groove or this trench of the depression 12 is completely filled with Hg-containing material 17 in the embodiment shown. This means that the material 17 is introduced up to the transitions or edges 18 and 19 and therefore a flush and substantially planar transition from the material surface of the material 17 to the adjacent surfaces is formed in line with the upper sides 15 of the carrier element 11. The Hg-containing material 17 in the exemplary embodiment furthermore also comprises getter material. Both mercury and getter material is therefore mixed in the depression 12. A zirconium/aluminum getter, for example, can be provided as the getter material. The mercury-containing material may be a mercury/titanium alloy.

Since the dimensions (w1, t1, b1) of the depression 12 are known very precisely, the volume can also be determined very precisely, and therefore the quantity of mercury can also be metered very precisely. Since the mercury concentration in the material 17 per unit quantity is generally known, the mercury concentration of the carrier element 11 can therefore also be metered very precisely depending on the volume of the depression 12. It is possible for metering to take place very precisely depending on the concentration of the mercury in the material 17 and/or on the number of depressions 12 in the carrier element 11 and/or on the volume of at least one depression 12 and it is therefore also possible for very small quantities of mercury to be set precisely.

The carrier element 11 shown in FIG. 2 is produced in such a way that, first, the carrier element 11 provided as a metal strip is shaped in a corresponding way to the illustration in FIG. 2. In particular, for this purpose bending with respect to the production of the trench for the depression 12 is carried out. Subsequently, the pulverulent Hg-containing material 17, which also has getter material in the exemplary embodiment, is then distributed over the carrier element 11. In particular, material is introduced into the depression 12 in the process. This takes place via a vibration system, the material 17 being pressed exclusively in the depression 12 once it has been applied to the carrier element 11. After this pressing of the local region, the rest of the quantity of material 17 remaining on the upper sides 15 which has not already been pressed there is then subsequently sucked away. In the case of the carrier element 11 illustrated in FIG. 2, the upper sides 15 and the lower sides 16 are therefore free from mercury-containing material and also free from getter material.

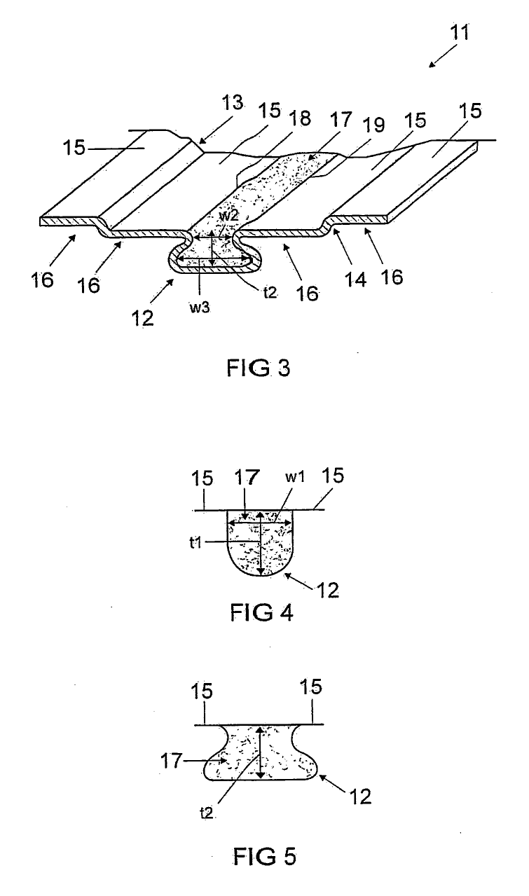

FIG. 3 shows a further exemplary embodiment of a carrier element 11 in a perspective view. In contrast to the embodiment shown in FIG. 2, this figure illustrates a depression 12 in the form of a groove which is not shaped in the form of a U in cross section, but is widened towards the bottom and demonstrates a bulbous structure. This is achieved by flat-pressing the carrier element 11 with rollers. In the region of the edges 18 and 19, the depression 12 has a width w2 which is less than a width w3 in the depression 12.

The depressions 12 in FIGS. 2 and 3 are in the form of elongate, linear grooves. However, a nonlinear profile may also be provided.

FIGS. 4 and 5 show enlarged illustrations of the cross sections of the embodiments in FIGS. 2 and 3 in the region of the depressions 12.

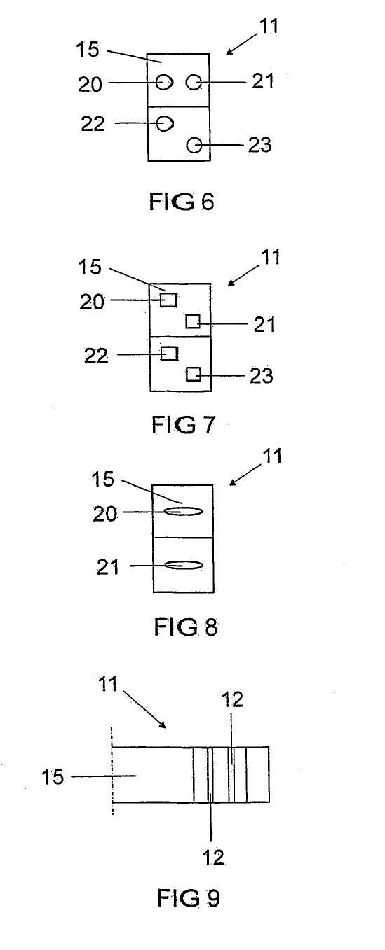

FIG. 6 shows a further exemplary embodiment of a carrier element 11 in a plan view illustration, with only the detail of the carrier element 11 being shown, in which a plurality of depressions 20, 21, 22 and 23 is formed. In this embodiment, the depressions 20 to 23 are not designed as elongate grooves or the like, but as blind holes. In accordance with the illustration in FIG. 6, these depressions 20 to 23 have a corner-free, and in particular round hole structure.

FIG. 7 shows a further embodiment of a carrier element 11, which, in contrast to the illustration shown in FIG. 6, has a plurality of depressions 20 to 23, which do not have a round geometry in a plan view from above but are angular, in particular rectangular.

FIG. 8 shows an embodiment in which, in contrast to the plan view illustrations in FIGS. 6 and 7, only two depressions 20 and 21 are provided, which, when viewed in plan view, demonstrate an oval geometry.

FIG. 9 shows a further schematic illustration of a carrier element 11 in plan view, in which two depressions 12 are shown which are in the form of elongate grooves and are provided spaced apart from one another and parallel to one another. The depressions 12 in FIG. 9 can be provided, for example, in accordance with the configurations in FIGS. 2 or 3. Both depressions 12 can be designed to be identical or else different in terms of their dimensions and/or geometry.

For example, in the embodiment illustrated in FIG. 2, the width w1 may be 1 mm. The depth t1 may likewise be 1 mm or else more. These are merely exemplary values which may be higher or lower. In particular, the configuration of the depression 12 can result in very precise metering of the quantity of mercury, with it being possible for this quantity to be less than or equal to 4 mg per carrier element 11. In particular, very low quantities of mercury of less than or equal to 1 mg can also be metered very precisely.

1. A carrier element, on which an Hg-containing material for application in a discharge lamp (1) is formed, characterized in that the carrier element (11) has at least one depression (12, 20 to 23), in which the Hg-containing material (17) is arranged.

2. The carrier element as claimed in claim 1, characterized in that the Hg-containing material (17) is formed exclusively in the depression (12, 20 to 23).

3. The carrier element as claimed in claim 1, characterized in that a depression (12, 20 to 23) is in the form a groove.

4. The carrier element as claimed in claim 1, characterized in that a depression (12, 20 to 23) is in the form of a type of blind hole.

5. The carrier element as claimed in claim 1, characterized in that a depression (12, 20 to 23) is completely filled with Hg-containing material (17).

6. The carrier element as claimed in claim 1, characterized in that getter material is arranged in the depression (12, 20 to 23).

7. The carrier element as claimed in claim 1, characterized in that the Hg-containing material (17) is a powder.

8. The carrier element as claimed in claim 1, characterized in that the Hg-containing material (17) is pressed into the depression (12, 20 to 23).

9. The carrier element as claimed in claim 1, characterized in that it is in the form of a metal strip.

10. The carrier element as claimed in claim 1, characterized in that the quantity of Hg can be metered depending on the concentration of the Hg in the material (17) formed in the depression (12, 20 to 23) and/or on the number of depressions (12, 20 to 23) and/or on the volume of at least one depression (12, 20 to 23).

11. The carrier element as claimed in claim 1, characterized in that at least one second depression (12, 20 to 23) is formed in which Hg-free material, in particular getter material, is formed.

12. A discharge lamp with a discharge vessel (2) and at least one electrode (10) arranged therein, and with a carrier element (11) as claimed in claim 1 which is arranged in the discharge vessel (2).

13. The discharge lamp as claimed in claim 12, characterized in that the carrier element (11) is arranged on an electrode frame (3).

14. The discharge lamp as claimed in claim 12, characterized in that the carrier element (11) is arranged so as to surround at least regions of the electrode (10), in particular so as to surround it in annular fashion.

15. A method for producing a carrier element (11) having Hg-containing material (17) for a discharge lamp (1), in which at least one depression (12, 20 to 23) is formed in the carrier element (11), and the Hg-containing material (17) is introduced into the depression.

16. The method as claimed in claim 15, characterized in that the Hg-containing material (17) is distributed over the carrier element (11) as a powder and only the material (17) located in the depression (12, 20 to 23) is pressed once it has been introduced.

17. The method as claimed in claim 16, characterized in that the Hg-containing material (17) which is located outside the depression (12, 20 to 23) is removed, in particular sucked away, after the pressing of the Hg-containing material (17) contained in the depression (12, 20 to 23).

18. The discharge lamp as claimed in claim 13, characterized in that the carrier element (11) is arranged so as to surround at least regions of the electrode (10), in particular so as to surround it in annular fashion.

19. The carrier element as claimed in claim 2, characterized in that a depression (12, 20 to 23) is in the form a groove.

20. The carrier element as claimed in claim 2, characterized in that a depression (12, 20 to 23) is in the form of a type of blind hole.
